(19) United States
(12) Patent Application Publication
(10) Pub. No.: US 2025/0391295 A1
(43) Pub. Date: Dec. 25, 2025

(54) DISPLAY DEVICE, METHOD FOR DRIVING DISPLAY DEVICE AND ELECTRONIC DEVICE INCLUDING DISPLAY DEVICE

(71) Applicant: Samsung Display Co., LTD., Yongin-si (KR)

(72) Inventors: Yeon Shil JUNG, Yongin-si (KR); Joo Ho LIM, Yongin-si (KR)

(21) Appl. No.: 19/011,442

(22) Filed: Jan. 6, 2025

(30) Foreign Application Priority Data
Jun. 21, 2024 (KR) 10-2024-0080932
Jul. 15, 2024 (KR) 10-2024-0093269

(51) Int. Cl. G09G 3/00; G09G 3/32

(52) U.S. Cl. CPC G09G 3/006; G09G 3/32; G09G 2300/0819; G09G 2300/0842; G09G 2300/0861; G09G 2310/08; G09G 2320/0233; G09G 2320/0276; G09G 2320/0285; G09G 2330/10; G09G 2354/00

(57) ABSTRACT

One or more embodiments provides a display device including a display panel including pixels, a scan driver configured to provide a scan signal to the display panel, a data driver configured to provide a data signal corresponding to the pixels to the display panel, a timing controller configured to control the driving of the scan driver and the data driver, and a data converter configured to convert image data output from the timing controller to conversion data corresponding to a first pixel of the pixels based on whether the first pixel is defective, and to generate the data signal.

### CROSS-REFERENCE TO RELATED APPLICATION

The present application claims priority to, and the benefit of, Korean Patent Application No. 10-2024-0080932, filed on Jun. 21, 2024, in the Korean Intellectual Property Office, and Korean Patent Application No. 10-2024-0093269, filed on Jul. 15, 2024, in the Korean Intellectual Property Office, the entire disclosures of which are incorporated herein by reference.

### BACKGROUND

### 1. Field

The present disclosure relates to a display device, a method for driving the display device and an electronic device including the display device.

### 2. Description of the Related Art

As information technology develops, the importance of a display device as a connecting medium between a user and information is increasing. In response to this, the utilization of display devices such as a liquid crystal display device and an organic light-emitting display device is increasing.

A plurality of transistors may be utilized to form (or provide) a pixel circuit of a display device. In the process of manufacturing the display device, if a defect occurs in some of the transistors, a problem may occur in which the corresponding pixel is recognized as a bright spot.

### SUMMARY

The present disclosure provides a display device and a method for driving the same that may alleviate the occurrence of a defective pixel included in a display panel being recognized as a bright spot.

One or more embodiments provides a display device including a display panel including pixels, a scan driver configured to provide a scan signal to the display panel, a data driver configured to provide a data signal corresponding to the pixels to the display panel, a timing controller configured to control the driving of the scan driver and the data driver, and a data converter configured to convert image data output from the timing controller to conversion data corresponding to a first pixel of the pixels based on whether the first pixel is defective, and to generate the data signal.

The data converter may be configured to generate the conversion data having a lower grayscale than a grayscale of the image data when the first pixel is defective, and to generate the conversion data having a same grayscale as the image data when the first pixel is not defective.

The data converter may be configured to generate the conversion data corresponding to a grayscale of black when the first pixel is defective.

The data converter may be configured to multiply the image data by a correction coefficient that is greater than 0 and that is less than 1, and may be configured to generate a result of a multiplication as the conversion data, when the first pixel is defective.

The correction coefficient may be based on a driving frequency of the display device and the grayscale of the image data.

The data converter may be configured to generate the conversion data having a lower grayscale than a grayscale of the image data when the first pixel is defective and a driving frequency of the display device is lower than a reference frequency, wherein the data converter is configured to generate the conversion data having a same grayscale as the image data when the first pixel is not defective or when the driving frequency of the display device is lower than the reference frequency.

The data converter may include an edge data determiner configured to determine whether the first pixel is defective, and configured to generate a control signal, and a data generator configured to selectively convert the image data based on the control signal, and configured to generate the conversion data.

The data converter may further include a digital-to-analog converter configured to convert the conversion data into the data signal.

The data converter may further include a lookup table storage configured to store a lookup table including correction coefficients corresponding to the driving frequency of the display device and the grayscale of the image data.

A size of a corresponding one of the correction coefficients may decrease as a grayscale of the image data increases.

A size of a corresponding one of the correction coefficients may decrease as the driving frequency decreases.

One or more other embodiments provides a method of operating a display device, the method including receiving image data corresponding to a first pixel among pixels in a display panel, determining the first pixel is defective, and generating conversion data from the image data.

The conversion data may have a lower grayscale than a grayscale of the image data.

The conversion data may correspond to a grayscale of black.

The generating the conversion data may include providing a correction coefficient corresponding to a grayscale of the image data and a driving frequency of the display device by referring to a lookup table, and applying the correction coefficient to the image data to generate the conversion data.

The correction coefficient may be greater than 0 and is less than 1.

Another method of operating a display device may include receiving image data corresponding to a first pixel among pixels in a display panel, determining the first pixel is defective, determining a driving frequency of the display panel is less than a reference frequency, and generating conversion data from the image data.

The conversion data may correspond to a grayscale of black.

The generating the conversion data may include multiplying the image data by a correction coefficient that is greater than 0 and that is less than 1, and generating a result of a multiplication as the conversion data.

Another embodiment provides an electronic device including a processor to provide input image data, and a display device to display an image based on the input image data. The display device includes a display panel including pixels, a scan driver configured to provide a scan signal to the display panel, a data driver configured to provide a data signal corresponding to the pixels to the display panel, a timing controller configured to control the driving of the scan driver and the data driver, and a data converter configured to convert image data output from the timing controller to conversion data corresponding to a first pixel of the pixels based on whether the first pixel is defective, and to generate the data signal.

According to the display device and the method for driving the same according to the embodiments of the present disclosure, the occurrence of a defective pixel included in a display panel being recognized as a bright spot can be alleviated.

However, the aspects of the present disclosure are not limited to the aspects described above and may be variously expanded within the scope that does not depart from the spirit and scope of the present disclosure.

### BRIEF DESCRIPTION OF THE DRAWINGS

FIG. 1 is a block diagram illustrating a display device according to one or more embodiments of the present disclosure.

FIG. 2 is a circuit diagram illustrating one or more embodiments of a pixel according to one or more embodiments.

FIG. 3 is a graph for explaining the amount of change in voltage-current characteristics if a transistor deteriorates.

FIGS. 4A, 4B, and 4C are graphs for explaining the brightness change of a defective pixel according to the driving frequency of the display device.

FIG. 5 is a block diagram illustrating a display device according to one or more other embodiments of the present disclosure.

FIG. 6 is a block diagram illustrating one or more embodiments of the data converter in FIG. 5.

FIG. 7 is a flowchart illustrating an operating method of a display device according to one or more other embodiments of the present disclosure.

FIG. 8 is a flowchart illustrating an operating method of a display device according to one or more other embodiments of the present disclosure.

FIG. 9 is a block diagram illustrating one or more other embodiments of the data converter in FIG. 5.

FIG. 10 is a flowchart illustrating an operating method of a display device according to one or more other embodiments of the present disclosure.

FIG. 11 is a drawing illustrating an electronic device according to one or more other embodiments of the present disclosure.

### DETAILED DESCRIPTION S

Aspects of some embodiments of the present disclosure and methods of accomplishing the same may be understood more readily by reference to the detailed description of embodiments and the accompanying drawings. The described embodiments are provided as examples so that this disclosure will be thorough and complete, and will fully convey the aspects of the present disclosure to those skilled in the art. Accordingly, processes, elements, and techniques that are redundant, that are unrelated or irrelevant to the description of the embodiments, or that are not necessary to those having ordinary skill in the art for a complete understanding of the aspects of the present disclosure may be omitted. Unless otherwise noted, like reference numerals, characters, or combinations thereof denote like elements throughout the attached drawings and the written description, and thus, repeated descriptions thereof may be omitted.

The described embodiments may have various modifications and may be embodied in different forms, and should not be construed as being limited to only the illustrated embodiments herein. The use of “can,” “may,” or “may not” in describing one or more embodiments corresponds to one or more embodiments of the present disclosure.

A person of ordinary skill in the art would appreciate, in view of the present disclosure in its entirety, that each suitable feature of the various embodiments of the present disclosure may be combined or combined with each other, partially or entirely, and may be technically interlocked and operated in various suitable ways, and each embodiment may be implemented independently of each other or in conjunction with each other in any suitable manner unless otherwise stated or implied.

It will be understood that when an element, layer, region, or component (e.g., an apparatus, a device, a circuit, a wire, an electrode, a terminal, a conductive film, etc.) is referred to as being “formed on,” “on,” “connected to,” or “(operatively, functionally, or communicatively) coupled to” another element, layer, region, or component, it can be directly formed on, on, connected to, or coupled to the other element, layer, region, or component, or indirectly formed on, on, connected to, or coupled to the other element, layer, region, or component such that one or more intervening elements, layers, regions, or components may be present. In addition, this may collectively mean a direct or indirect coupling or connection and an integral or non-integral coupling or connection. For example, when a layer, region, or component is referred to as being “electrically connected” or “electrically coupled” to another layer, region, or component, it can be directly electrically connected or coupled to the other layer, region, and/or component or one or more intervening layers, regions, or components may be present. The one or more intervening components may include a switch, a transistor, a resistor, an inductor, a capacitor, a diode and/or the like. Accordingly, a connection is not limited to the connections illustrated in the drawings or the detailed description and may also include other types of connections. In describing embodiments, an expression of connection indicates electrical connection unless explicitly described to be direct connection, and “directly connected/directly coupled,” or “directly on,” refers to one component directly connecting or coupling another component, or being on another component, without an intermediate component. Meanwhile, other expressions describing relationships between components, such as “between,” “immediately between” or “adjacent to” and “directly adjacent to,” may be construed similarly. It will be understood that when an element or layer is referred to as being “between” two elements or layers, it can be the only element or layer between the two elements or layers, or one or more intervening elements or layers may also be present.

For the purposes of this disclosure, expressions such as “at least one of,” or “any one of,” or “one or more of” when preceding a list of elements, modify the entire list of elements and do not modify the individual elements of the list. For example, “at least one of X, Y, and Z,” “at least one of X, Y, or Z,” “at least one selected from the group consisting of X, Y, and Z,” and “at least one selected from the group consisting of X, Y, or Z” may be construed as X only, Y only, Z only, any combination of two or more of X, Y, and Z, such as, for instance, XYZ, XYY, YZ, and ZZ, or any variation thereof. Similarly, the expressions “at least one of A and B” and “at least one of A or B” may include A, B, or A and B. As used herein, “or” generally means “and/or,” and the term “and/or” includes any and all combinations of one or more of the associated listed items. For example, the expression “A and/or B” may include A, B, or A and B. Similarly, expressions such as “at least one of,” “a plurality of,” “one of,” and other prepositional phrases, when preceding a list of elements, modify the entire list of elements and do not modify the individual elements of the list. When “C to D” is stated, it means C or more and D or less, unless otherwise specified.

It will be understood that, although the terms “first,” “second,” “third,” etc., may be used herein to describe various elements, components, regions, layers and/or sections, these elements, components, regions, layers and/or sections should not be limited by these terms. These terms do not correspond to a particular order, position, or superiority, and are used only used to distinguish one element, member, component, region, area, layer, section, or portion from another element, member, component, region, area, layer, section, or portion. Thus, a first element, component, region, layer or section described below could be termed a second element, component, region, layer or section, without departing from the spirit and scope of the present disclosure. The description of an element as a “first” element may not require or imply the presence of a second element or other elements. The terms “first,” “second,” etc. may also be used herein to differentiate different categories or sets of elements. For conciseness, the terms “first,” “second,” etc. may represent “first-category (or first-set),” “second-category (or second-set),” etc., respectively.

The terminology used herein is for the purpose of describing embodiments only and is not intended to be limiting of the present disclosure. As used herein, the singular forms “a” and “an” are intended to include the plural forms as well, while the plural forms are also intended to include the singular forms, unless the context clearly indicates otherwise. It will be further understood that the terms “comprises,” “comprising,” “have,” “having,” “includes,” and “including,” when used in this specification, specify the presence of the stated features, integers, steps, operations, elements, and/or components, but do not preclude the presence or addition of one or more other features, integers, steps, operations, elements, components, and/or groups thereof.

When one or more embodiments may be implemented differently, a specific process order may be performed differently from the described order. For example, two consecutively described processes may be performed substantially at the same time or performed in an order opposite to the described order.

As used herein, the terms “substantially,” “about,” “approximately,” and similar terms are used as terms of approximation and not as terms of degree, and are intended to account for the inherent deviations in measured or calculated values that would be recognized by those of ordinary skill in the art. For example, “substantially” may include a range of +/−5% of a corresponding value. “About” or “approximately,” as used herein, is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” may mean within one or more standard deviations, or within +30%, 20%, 10%, 5% of the stated value. Further, the use of “may” when describing embodiments of the present disclosure refers to “one or more embodiments of the present disclosure.”

In some embodiments well-known structures and devices may be described in the accompanying drawings in relation to one or more functional blocks (e.g., block diagrams), units, and/or modules to avoid unnecessarily obscuring various embodiments. Those skilled in the art will understand that such block, unit, and/or module are/is physically implemented by a logic circuit, an individual component, a microprocessor, a hard wire circuit, a memory element, a line connection, and other electronic circuits. This may be formed using a semiconductor-based manufacturing technique or other manufacturing techniques. The block, unit, and/or module implemented by a microprocessor or other similar hardware may be programmed and controlled using software to perform various functions discussed herein, optionally may be driven by firmware and/or software. In addition, each block, unit, and/or module may be implemented by dedicated hardware, or a combination of dedicated hardware that performs some functions and a processor (for example, one or more programmed microprocessors and related circuits) that performs a function different from those of the dedicated hardware. In addition, in some embodiments, the block, unit, and/or module may be physically separated into two or more interact individual blocks, units, and/or modules without departing from the scope of the present disclosure. In addition, in some embodiments, the block, unit and/or module may be physically combined into more complex blocks, units, and/or modules without departing from the scope of the present disclosure.

Unless otherwise defined, all terms (including technical and scientific terms) used herein have the same meaning as commonly understood by one of ordinary skill in the art to which the present disclosure belongs. It will be further understood that terms, such as those defined in commonly used dictionaries, should be interpreted as having a meaning that is consistent with their meaning in the context of the relevant art and/or the present specification, and should not be interpreted in an idealized or overly formal sense, unless expressly so defined herein.

Hereinafter, embodiments are described in detail with reference to the accompanying drawings so that those skilled in the art may easily practice the disclosure. The disclosure may be implemented in one or more suitable different forms and is not limited to the example embodiments described in the specification.

A part irrelevant to the description may not be provided to clearly describe the disclosure, and the same or similar constituent elements may be designated by the same reference numerals throughout the specification. Therefore, the same reference numerals may be utilized in different drawings to identify the same or similar elements.

In one or more embodiments, the expression “the same” in the description may refer to “substantially the same.” For example, it may be the same to the extent that a person with ordinary knowledge can understand that it is the same. Other expressions may also be expressions in which “substantially” is not provided.

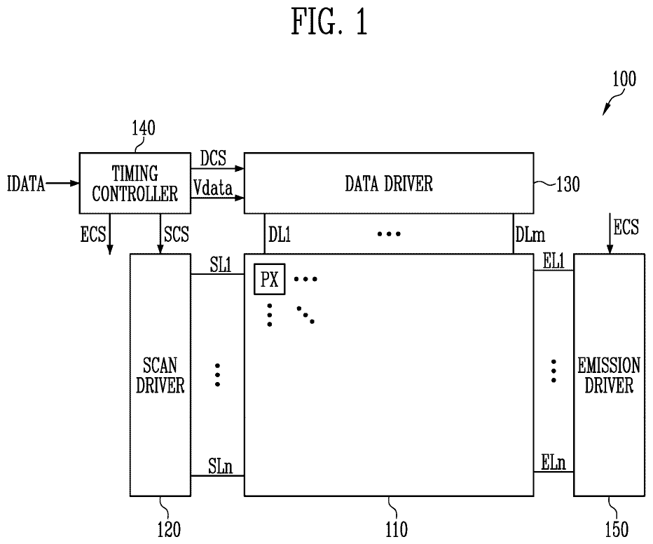

FIG. 1 is a block diagram illustrating a display device according to one or more embodiments of the present disclosure. Referring to FIG. 1, the display device 100 may include a display unit 110 (or a display panel), a scan driver 120, a data driver 130, a timing controller 140, and an emission driver 150.

The display unit 110 may include scan lines SL1 to SLn (where n is a positive integer), data lines DL1 to DLm (where m is a positive integer), emission control lines EL1 to ELn, and pixels PX. The display unit 110 may include a plurality of pixels PX, and each pixel PX may be connected to one of the scan lines SL1 to SLn, one of the data lines DL1 to DLm, and one of the emission control lines EL1 to ELn.

For example, a pixel located in the i-th row and the j-th column may store or record a data signal (or data voltage) provided through the j-th data line DLj in response to a scan signal provided through the i-th scan line SLi and may be to emit light with a brightness corresponding to the stored data signal in response to an emission control signal provided through the i-th emission control line Eli.

The scan driver 120 may generate a scan signal based on the scan control signal SCS and sequentially provide the scan signal to the scan lines SL1 to SLn. Here, the scan control signal SCS includes a start signal, clock signals, and/or the like and may be provided from the data driver 130. For example, the scan driver 120 may include a shift register that sequentially outputs a scan signal corresponding to a pulse-type start signal utilizing clock signals.

The emission driver 150 may generate an emission control signal based on an emission driving control signal ECS, and may provide the emission control signal to the emission control lines EL1 to ELn sequentially or concurrently (e.g., substantially simultaneously). For example, the emission driver 150 may include a shift register that sequentially outputs an emission control signal corresponding to a pulse-type emission start signal utilizing emission clock signals.

The timing controller 140 may receive input image data IDATA from the outside, and may generate a scan control signal SCS, an emission control signal ECS, and a data control signal DCS. In one or more embodiments, the timing controller 140 may generate a data signal Vdata from the input image data DATA1.

For example, the timing controller 140 may convert input image data IDATA1 in RGB format into image data in a format that matches the pixel arrangement in the display unit 110, and may generate a data signal Vdata corresponding to the converted image data. At this time, the timing controller 140 may convert the input grayscale value included in the converted image data into a data signal Vdata utilizing a gamma lookup table GLUT.

The data driver 130 may generate data signals based on the data control signal DCS and the data signal Vdata, and may provide the data signals Vdata to the display unit 110. Here, the data control signal DCS may be a signal that controls the operation of the data driver 130 and may include a load signal (or a data enable signal) that instructs the output of a valid data signal.

For example, the data driver 130 may be configured to include a shift register, a latch, a decoder, an output buffer, and/or the like, and the data driver 130 may sequentially provide or temporarily store a data signal Vdata to the shift register and the latch based on a data control signal DCS, and may output a data signal corresponding to the data signal Vdata to the data line through the decoder.

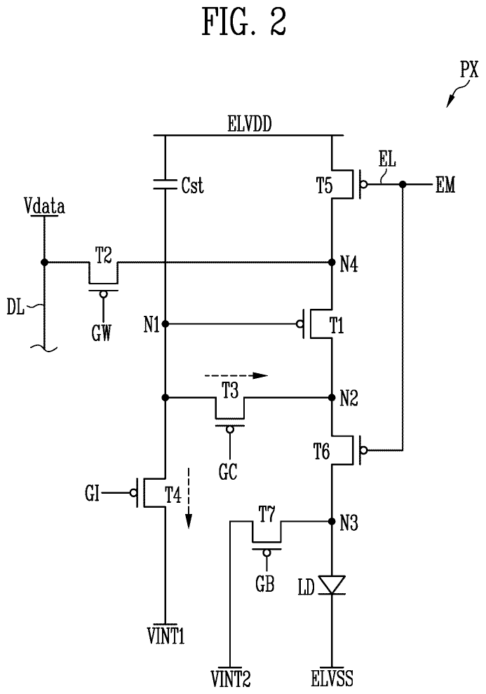

FIG. 2 is a circuit diagram illustrating an example of a pixel according to one or more embodiments.

Referring to FIG. 2, the pixel PX may include first to seventh transistors T1 to T7, a storage capacitor Cst, and a light-emitting element LD. The first transistor T1 (for example, a driving transistor) includes a control electrode connected to a first node N1, a first electrode connected to a fourth node N4, and a second electrode connected to a second node N3. The second transistor T1 includes a control electrode for receiving a writing gate signal GW, a first electrode for receiving a data voltage Vdata, and a second electrode connected to the fourth node N4. The third transistor T3 includes a control electrode for receiving a compensation gate signal GC, a first electrode connected to the second node N2, and a second electrode connected to the first node N1. The fourth transistor T4 includes a control electrode for receiving an initialization gate signal GI, a first electrode for receiving a first initialization voltage VINT1, and a second electrode connected to the first node N1. The fifth transistor T5 includes a control electrode for receiving an emission control signal EM, a first electrode for receiving a first power supply voltage ELVDD (for example, a high power supply voltage), and a second electrode connected to the fourth node N4. The sixth transistor T6 includes a control electrode for receiving an emission control signal EM, a first electrode connected to the second node N2, and a second electrode connected to the third node N3. The seventh transistor T7 includes a control electrode for receiving a bias gate signal GB, a first electrode for receiving a second initialization voltage VINT2 (for example, an anode initialization voltage), and a second electrode connected to the third pixel node N3.

In one or more embodiments, the storage capacitor Cst includes a first electrode for receiving a first power supply voltage ELVDD and a second electrode connected to the first node N1. The light-emitting element LD includes a first electrode (for example, an anode electrode) connected to the third node N3 and a second electrode (for example, a cathode electrode) for receiving a second power supply voltage ELVSS (for example, a relatively low power supply voltage). The data voltage Vdata may be transmitted through the data line DL, and the emission control signal EM may be transmitted through the emission control line EL.

However, the present disclosure is not limited to the structure of the pixel PX illustrated in FIG. 2. For example, each of the pixels PX may have a structure such as a 3T1C structure including (e.g., consisting of) three transistors and one capacitor, a 5T2C structure including (e.g., consisting of) five transistors and two capacitors, an 8T1C structure including (e.g., consisting of) eight transistors and one capacitor, a 9T1C structure including (e.g., consisting of) nine transistors and one capacitor, and/or the like.

At least one of the first to seventh transistors T1, T2, T3, T4, T5, T6, and T7 may be implemented as a p-channel metal oxide semiconductor (PMOS) transistor. The relatively low voltage level of the PMOS transistor may be an activation level, and the high voltage level a deactivation level. For example, if a signal applied to a control electrode of a PMOS transistor has a relatively low voltage level, the PMOS transistor may be turned on. For example, if a signal applied to a control electrode of a PMOS transistor has a high voltage level, the PMOS transistor may be turned off.

At least one of the first to seventh transistors T1, T2, T3, T4, T5, T6, and T7 may be implemented as an NMOS (n-channel metal oxide semiconductor; NMOS) transistor. The high voltage level of the NMOS transistor may be an activation level, and the relatively low voltage level may be a deactivation level. For example, if a signal applied to a control electrode of the NMOS transistor has a high voltage level, the NMOS transistor may be turned on. For example, if a signal applied to a control electrode of the NMOS transistor has a relatively low voltage level, the NMOS transistor may be turned off. For example, the activation level and the deactivation level may be determined according to the type or kind of the transistor.

In the pixel PX in FIG. 2, the first, second, and fifth to seventh transistors T1, T2, T5, T6, and T7 are PMOS transistors, and the third and fourth transistors T3 and T4 are NMOS transistors. However, this is an example, and the present disclosure is not limited thereto.

For example, in the initialization section, the initialization gate signal GI may have an activation level, and the fourth transistor T4 may be turned on. Accordingly, the first initialization voltage VINT1 may be applied to the first node PN1. For example, the control electrode (for example, the storage capacitor Cst) of the first transistor T1 may be initialized.

For example, in the threshold voltage compensation section, the compensation gate signal GC may have an activation level, and the third transistor T3 may be turned on. Accordingly, the first transistor T1 may be diode-connected.

For example, in the data writing section, the writing gate signal GW may have an activation level, and the second transistor T2 and the third transistor T3 may be turned on. Accordingly, the voltage of the first node N1 may have a voltage that compensates for the threshold voltage of the first transistor T1 to the data signal. Accordingly, the data voltage Vdata may be written to the storage capacitor Cst.

For example, in the anode initialization section, the bias gate signal GB may have an activation level, and the seventh transistor T7 may be turned on. Accordingly, the second initialization voltage VINT2 may be applied to the first electrode (for example, the anode electrode) of the light-emitting element LD.

For example, in the emission section, the emission control signal EM may have an activation level, and the fifth transistor T5 and the sixth transistor T6 may be turned on. Accordingly, the first power supply voltage ELVDD may be applied to the first transistor T1, so that a driving current may be generated, and the driving current may be applied to the light-emitting element LD. For example, the light-emitting element LD may be to emit light with a brightness corresponding to the driving current.

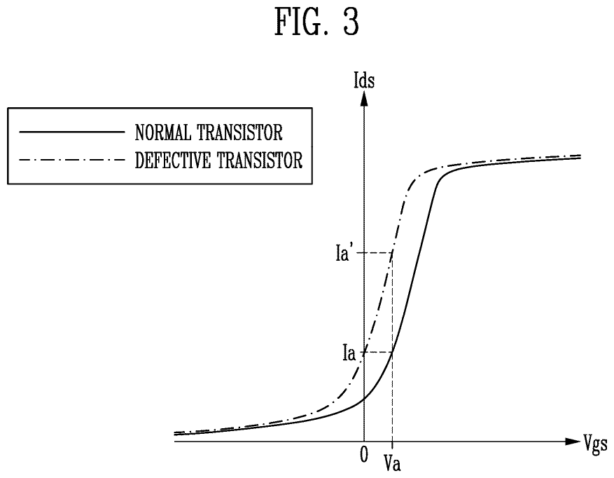

A defect may occur in some pixels during the manufacturing process of the display device. For example, a defect may occur in the third transistor or the fourth transistor illustrated in FIG. 2. In this case, as indicated by the dotted arrow in FIG. 2, a leakage current may occur from the first node N1 through the third transistor T3 or the fourth transistor T4. If a leakage current occurs through the third transistor T3 or the fourth transistor T4, the voltage of the first node N1 may change. The following description may be made with reference to FIG. 3.

FIG. 3 is a graph for explaining the change in voltage-current characteristics if a transistor deteriorates. In FIG. 3, the voltage-current characteristics of a normal transistor are illustrated as solid lines, and the voltage-current characteristics of a defective transistor are illustrated as dotted lines.

Referring to FIG. 3, the voltage-current curve of a defective transistor has a shape that is shifted to the left compared to the voltage-current curve of a normal transistor. Accordingly, if the same gate-source voltage Vgs is applied, the drain-source current Ids of the defective transistor is greater than the drain-source current Ids of the normal transistor. For example, in FIG. 3, if the gate-source voltage Vs is voltage Va, the drain-source current Ids of the normal transistor has a current value Ia, whereas the drain-source current Ids of the defective transistor has a current value Ia′. The current value Ia′ is greater than the current value Ia. Therefore, the current corresponding to the difference between the current value Ia′ and the current value Ia may be viewed as a leakage current for the defective transistor.

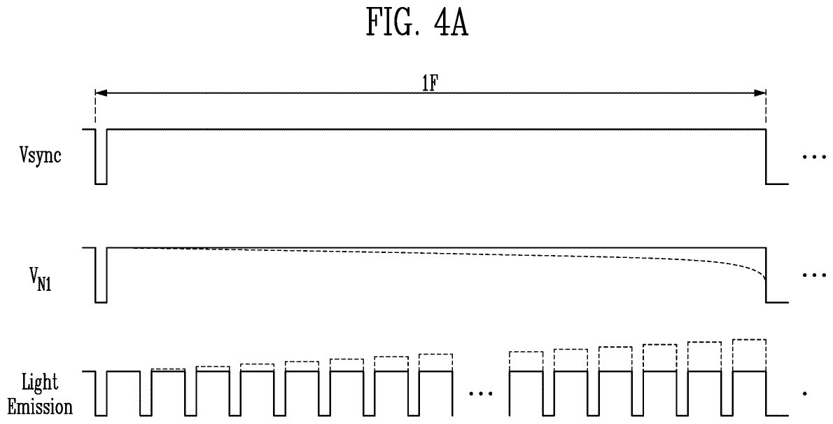

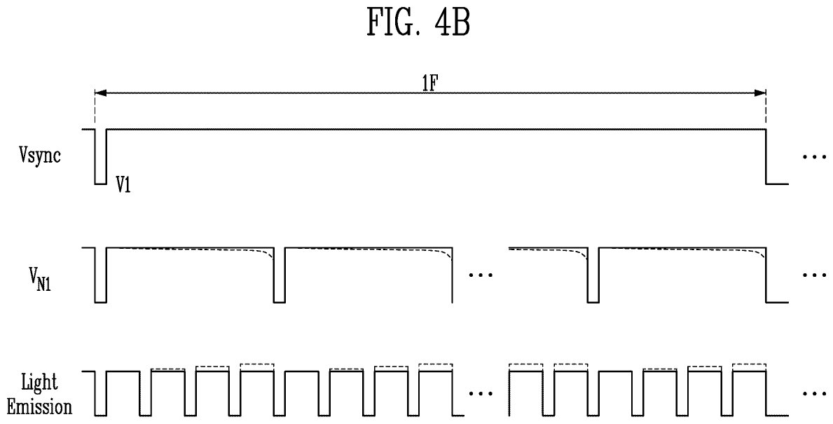

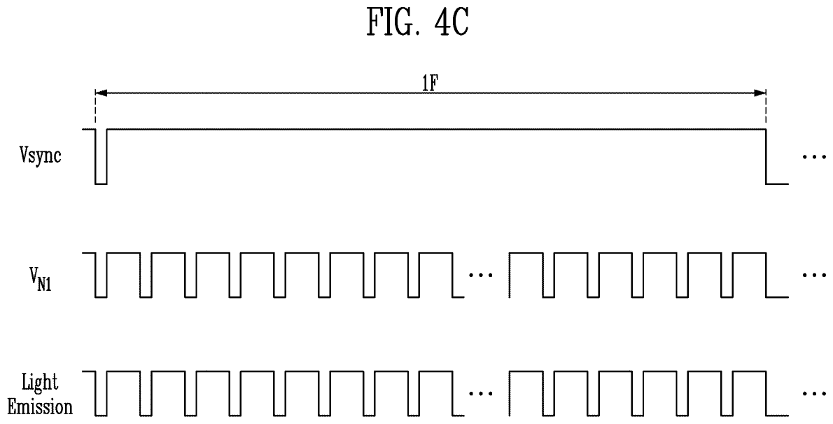

Referring to FIG. 4 together, if the third transistor T3 or the fourth transistor T4 is a defective transistor, the drain-source current Ids increases compared to the normal transistor. If a leakage current occurs through the third transistor T3 or the fourth transistor T4, the voltage of the first node N1 decreases over time, which may also affect the intensity of light generated by the light-emitting element LD included in the pixel PX. In one or more embodiments, if the pixel PX includes a defective transistor, the light generated by the light-emitting element LD may have different effects depending on the driving frequency of the display device. Hereinafter, this will be described with reference to FIGS. 4A to 4C.

FIGS. 4A, 4B, and 4C are graphs for explaining the brightness change of a defective pixel (e.g., bad pixel) according to the driving frequency of the display device. FIG. 4A is a graph for explaining the brightness change of a defective pixel if the driving frequency of the display device is a first frequency. FIG. 4B is a graph for explaining the brightness change of a defective pixel if the driving frequency of the display device is a second frequency greater than the first frequency. FIG. 4C is a graph for explaining the brightness change of a defective pixel if the driving frequency of the display device is a third frequency greater than the second frequency.

FIGS. 4A to 4C illustrate the vertical synchronization signal Vsync, the voltage V_{N1} of the first node N1, and the intensity of light generated by the light-emitting element if the driving frequencies of the display device are the first frequency, the second frequency, and the third frequency, respectively. Referring to FIGS. 4A to 4C, one frame may start as the vertical synchronization signal Vsync toggles. For example, the interval between the toggling points of the vertical synchronization signal Vsync may define one frame period 1F. For example, in FIGS. 4A to 4C, the voltage of the first node N1 and the intensity of light generated by the light-emitting element during one frame period are illustrated.

In FIGS. 4A to 4C, the light-emitting element LD of each pixel included in the display panel may not emit light if the emission control signal EM referred to in FIG. 2 is a high voltage, and the light-emitting element LD may be to emit light if the emission control signal EM is a relatively low voltage. Therefore, the emission pattern of the display panel in FIGS. 4A to 4C may have an opposite phase to the emission control signal EM.

In FIGS. 4A to 4C, the light-emitting element may generate light a number of times (e.g., a set or predetermined number of times) during one frame period 1F. For example, the light-emitting element may generate light 16 times during one frame period 1F.

The emission control signal EM toggles to a relatively low voltage four times according to the cycle T. Therefore, the emission pattern of the display panel may also toggle four times according to the cycle T.

Referring to FIG. 4A, the voltage V_{N1} of the first node N1 is maintained during one frame period 1F. This refers to the intensity or amount of light generated by the light-emitting element LD of the pixel PX during one frame period 1F corresponding to one data voltage. If the length of one frame period 1F is T seconds, the voltage V_{N1} of the first node N1 of the pixel PX has one value. This refers to the display device displaying one image during T seconds, and therefore, in the example in FIG. 4A, the driving frequency of the display device becomes “1/T (Hz)”.

Referring to FIG. 4B, the voltage V_{N1} of the first node N1 is changed during one frame period 1F. As described above, it is assumed that the light-emitting element generates light 16 times during one frame period 1F. In this case, because the voltage V_{N1} of the first node N1 changes every time the light-emitting element generates light four times, the driving frequency of the display device in the example in FIG. 4A becomes “4/T (Hz)”.

Referring to FIG. 4C, the voltage V_{N1} of the first node N1 changes every time the light-emitting element generates light. For example, the voltage V_{N1} of the first node N1 changes 16 times during one frame period 1F in FIG. 4C. In this case, the driving frequency of the display device becomes “16/T (Hz)”.

In FIGS. 4A to 4C, the voltage V_{N1} of the first node N1 is indicated by a solid line if the transistors of the pixel, for example the third and fourth transistors T3 and T4, are normal transistors, and the voltage V_{N1} of the first node N1 is indicated by a dotted line if the third and fourth transistors T3 and T4 are defective transistors. In one or more embodiments, in FIGS. 4A to 4C, the intensity of light generated by the light-emitting element LD is indicated by a solid line if the transistors of the pixel, for example the third and fourth transistors T3 and T4, are normal transistors, and the intensity of light generated by the light-emitting element LD is indicated by a dotted line if the third and fourth transistors T3 and T4 are defective transistors.

Referring to FIG. 4A, the voltage V_{N1} of the first node N1 does not change during one frame period 1F. This refers to the write operation that sets the voltage of the first node N1 according to the data voltage Vdata transmitted from the data line DL being performed only once. If the transistors included in the pixel PX are normal transistors, the voltage V_{N1} of the first node N1 is maintained for one frame period 1F as indicated by the solid line in FIG. 4A. Accordingly, the intensity of light generated by the light-emitting element LD is maintained constant for a plurality of emission cycles within one frame period 1F.

However, if a leakage current flows in any one of the transistors included in the pixel PX, for example, the third or fourth transistors T3 and T4, the voltage V_{N1} of the first node N1 drops as indicated by the dotted line.

If the voltage V_{N1} of the first node N1, which is the gate voltage of the first transistor T1, which is a PMOS transistor, decreases, the drain-source current of the first transistor T1 increases. Accordingly, the intensity of light generated by the light-emitting element LD gradually increases if the fifth and sixth transistors are turned on. For example, in FIG. 4A, during the initial half cycles among the plurality of emission cycles within one frame period 1F, the voltage V_{N1} of the first node N1, which is the gate voltage of the first transistor T1, experiences a small decrease. Thus, if the third and fourth transistors T3 and T4 are normal transistors, the increase in the intensity of light generated by the light-emitting element LD is relatively small compared to the intensity of light generated by the light-emitting element LD if the transistors are defective transistors. In contrast, during the latter half cycles among the plurality of emission cycles within one frame period 1F, the voltage V_{N1} of the first node N1, which is the gate voltage of the first transistor T1, experiences a large decrease. Thus, if the third and fourth transistors T3 and T4 are normal transistors, the increase in the intensity of light generated by the light-emitting element LD is relatively large compared to the intensity of light generated by the light-emitting element LD if the transistors are defective transistors. Therefore, a bright spot defect may occur in which the light-emitting element LD of the pixel PX generates brighter light than the corresponding input image data.

In one or more embodiments, referring to FIG. 4B, the voltage V_{N1} of the first node N1 may change four times during one frame period 1F. Each time the voltage of the first node N1 changes, the process performed during the write operation after the voltage of the first node N1 is initialized is repeated.

Comparing FIG. 4A and FIG. 4B, in the case of FIG. 4A, the voltage V_{N1} of the first node N1 continues to decrease throughout the entire one frame period 1F. Accordingly, the light emitted from the light-emitting element of the pixel including the defective transistor may increase relatively more in the latter half of the one frame period 1F. In contrast, in the case of FIG. 4B, the voltage V_{N1} of the first node N1 is refreshed four times during the one frame period 1F. Therefore, the voltage V_{N1} of the first node N1 is initialized four times, so that the light emitted from the light-emitting element of the pixel including the defective transistor may increase relatively more in the latter half.

In one or more embodiments, referring to FIG. 4C, the voltage V_{N1} of the first node N1 may change 16 times during the one frame period 1F. In this case, the process performed during the write operation after the voltage of the first node N1 is initialized for each emission cycle of the pixel is repeated. For example, the voltage V_{N1} of the first node N1 is refreshed for each emission cycle. In this case, there may be almost no difference between the light generated from the light-emitting element if the third and fourth transistors T3 and T4 are normal transistors and the light generated from the light-emitting element if the third and fourth transistors T3 and T4 are defective transistors.

In summary, the lower the driving frequency of the display device, the greater the difference between the intensity of the light generated from the light-emitting element LD of the pixel PX including defective transistors and the intensity of the light generated from the light-emitting element LD of the pixel PX not including defective transistors. This refers to if the driving frequency is lower during the operation of the pixel PX including defective transistors, then the higher the possibility that a bright spot defect may be recognized.

In one or more embodiments, under the fixed driving frequency operation condition, if a pixel PX including defective transistors operates with high-grayscale input data, there is a higher possibility that a bright spot defect may be recognized compared to if operating with low-grayscale input data.

According to a display device and an operating method thereof according to one or more other embodiments of the present disclosure, input image data is converted according to a driving condition of a pixel to generate a data signal, and the generated data signal is transmitted to the pixel. The driving condition may include at least one of a driving frequency of the display device or a grayscale of the input image data. Accordingly, even if a pixel includes defective transistors, the problem of the light-emitting element generating excessive light and being recognized as a bright spot may be solved.

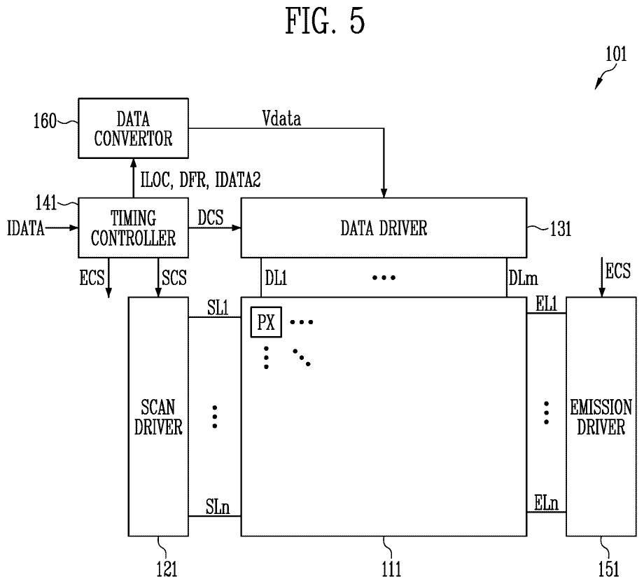

FIG. 5 is a block diagram illustrating a display device according to one or more other embodiments of the present disclosure.

Referring to FIG. 5, a display device 101 may include a display unit 111 (or display panel), a scan driver 121, a data driver 131, a timing controller 141, and an emission driver 151. In one or more embodiments, the display device 101 in FIG. 5 may further include a data converter 160. The display unit 111 (or display panel), the scan driver 121, the data driver 131, and the emission driver 151 in FIG. 5 each independently operate in substantially the same manner as the display unit 110 (or display panel), the scan driver 120, the data driver 130, and the emission driver 150 in FIG. 1, respectively. Therefore, redundant descriptions of these components will not be provided.

The timing controller 141 included in the display device 101 in FIG. 5 converts input image data IDATA1 in RGB format to generate second image data IDATA2 in a format that matches the pixel arrangement in the display unit 111, and transmits the generated image data IDATA2 to the data converter 160. In one or more embodiments, the timing controller 141 may be to transmit location data ILOC including information on the position of the second image data IDATA2 to the data converter 160. In one or more embodiments, the data converter 160 may determine whether a pixel corresponding to the second image data IDATA2 is a pixel including a defective transistor based on the location data ILOC.

In one or more embodiments, the timing controller 141 may be to transmit driving frequency information DFR of the display device 101 to the data converter 160. In one or more embodiments, the data converter 160 may convert the second image data IDATA2 based on the driving frequency information DFR.

The data converter 160 converts the second image data IDATA2 based on the received location data ILOC and the driving frequency information DFR. In one or more embodiments, the data converter 160 may convert the input grayscale value included in the converted image data into a data signal Vdata utilizing a gamma lookup table GLUT and transmit the data signal Vdata to the data driver 131.

In the one or more embodiments corresponding to FIG. 5, the data converter 160 is illustrated as being configured separately from the timing controller 141. However, the present disclosure is not limited thereto, and the data converter 160 may be configured to be integrated into the timing controller 141. As another example, the data converter 160 may exist outside the display device 101, in which case, the image data converted from the data converter 160 may be input to the timing controller of the display device.

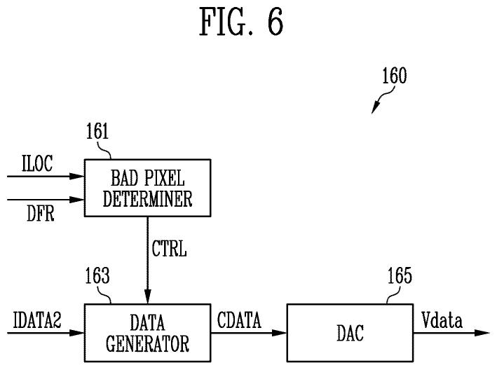

FIG. 6 is a block diagram illustrating one or more embodiments of the data converter in FIG. 5.

Referring to FIG. 6, the data converter 160 may include a defective pixel determiner 161, a data generator 163, and a digital-to-analog converter 165.

The defective pixel determiner 161 receives location data ILOC from the timing controller 141. The location data ILOC may indicate the position of a pixel corresponding to the second image data IDATA2. The defective pixel determiner 161 may determine whether a pixel corresponding to the second image data IDATA2 is defective based on the location data ILOC. To this end, the defective pixel determiner 161 may store the location data of defective pixels.

For example, in a test process after the manufacturing process of the display unit 111, it may be checked whether each pixel included in the display unit 111 is defective. For example, all pixels included in the display unit 111 may be configured to generate light corresponding to the same image data, and then the display unit 111 may be imaged utilizing a camera to detect pixels that generate different light from other pixels. In this process, location data of defective pixels may be generated. The generated location data may be stored in the defective pixel determiner 161. For example, information on the positions of defective pixels may be stored in the defective pixel determiner 161 in a list form.

During the operation of the display device 101, the defective pixel determiner 161 compares the location data ILOC indicating the position of the pixel corresponding to the second image data IDATA2 with the information on the positions of the defective pixels to determine whether the pixel corresponding to the second image data IDATA2 is defective.

According to the one or more embodiments corresponding to FIG. 6, the defective pixel determiner 161 may receive the driving frequency information DFR. As described in FIGS. 4A to 4C, if some transistors in the pixel are defective, the lower the driving frequency, the higher the probability that the corresponding pixel may be recognized as a bright spot. Therefore, the defective pixel determiner 161 generates a control signal CTRL for controlling the data generation operation of the data generator 166 based on the driving frequency information DFR if the pixel is defective.

The data generator 166 generates conversion data CDATA from the second image data IDATA2 based on the control signal CTRL received from the defective pixel determiner 161. The generated conversion data CDATA is transmitted to the digital-to-analog converter 165. The digital-to-analog converter 165 generates a data signal Vdata from the conversion data CDATA in a digital form.

As an example, if the pixel corresponding to the second image data IDATA2 is determined to be a normal pixel based on the location data ILOC, the defective pixel determiner 161 generates a control signal CTRL to control the data generator 163 to output the second image data IDATA2 as conversion data CDATA without conversion.

In one or more embodiments, if a pixel corresponding to the second image data IDATA2 is determined to be a defective pixel, the defective pixel determiner 161 may generate a control signal CTRL to control the data generator 163 to convert the second image data IDATA2, and may output the converted second image data as conversion data CDATA. In this case, the data generator 163 may output data corresponding to a grayscale value (e.g., a set or predetermined grayscale value) as the conversion data CDATA instead of the second image data IDATA2. As an example, the data generator 163 may output grayscale data having a grayscale of black as the conversion data CDATA instead of the second image data IDATA2.

For example, assume that the second image data IDATA2 corresponds to a grayscale of 30 among grayscales in a range of 0 to 255. If the pixel corresponding to the second image data IDATA2 is determined to be a normal pixel based on the location data ILOC, the data generator 163 may output the second image data IDATA2 having a grayscale of 30 as the conversion data CDATA based on the control signal CTRL.

In contrast, if the pixel corresponding to the second image data IDATA2 is determined to be a defective pixel based on the location data ILOC, the data generator 163 may output the grayscale data having a grayscale of 0 corresponding to black as the conversion data CDATA based on the control signal CTRL. The digital-to-analog converter DAC may generate a data signal Vdata having a voltage corresponding to black. Therefore, the pixel operates to emit light corresponding to black, not the second image data IDATA2. Accordingly, if the third or fourth transistor T3 and T4 which is the pixel PX is defective, the phenomenon of the pixel PX being recognized as a bright spot may be prevented or reduced. However, in this case, the pixel PX may be recognized as a dark spot. In terms of the criteria for determining a defect in the display unit 111, a dark spot may be more suitable than a bright spot. For example, the display unit 111 may be determined as defective if the number of pixels recognized as bright spots is n or more, and the display unit 111 may be determined as defective if the number of pixels recognized as dark spots is m or more. At this time, if m is greater than n, it may be more suitable for the pixel to be recognized as a dark spot than as a bright spot in determining a defect. Therefore, by converting data corresponding to a pixel PX that may be recognized as a bright spot into 0-grayscale data corresponding to black, the pixel may be configured to operate like a dark spot.

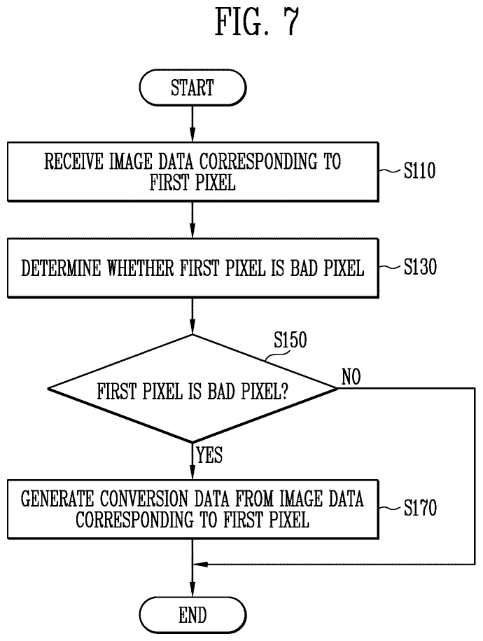

As another example, if a pixel corresponding to the second image data IDATA2 is determined to be a defective pixel based on the location data ILOC, the data generator 163 may multiply the second image data IDATA2 by a correction coefficient (e.g., a set or predetermined correction coefficient) based on the control signal CTRL, and may output the resulting generated data as conversion data CDATA. In one or more embodiments, the correction coefficient may be a number greater than 0 and less than 1. By multiplying the second image data IDATA2 by the correction coefficient, the conversion data CDATA has a lower grayscale than the original second image data IDATA2. Accordingly, the problem of pixels including defective transistors being recognized as bright spots is alleviated. The above-described embodiments will be described again with reference to FIG. 7.

In one or more other embodiments, if a pixel corresponding to the second image data IDATA2 is determined to be a defective pixel, the defective pixel determiner 161 may generate a control signal CTR based on the driving frequency information DFR. For example, even if a pixel corresponding to the second image data IDATA2 is determined to be a defective pixel, the defective pixel determiner 161 may generate a control signal CTRL to control the data generator 163 to convert the second image data IDATA2 only if the driving frequency is less than a preset reference frequency value.

For example, assume that the reference frequency is about 30 Hz. If the driving frequency of the current display device is lower than about 30 Hz (for example, about 10 Hz), and the pixel corresponding to the second image data IDATA2 is determined as a defective pixel, the data generator 163 may output the grayscale data having a grayscale of 0 corresponding to black as the conversion data CDATA based on the control signal CTRL.

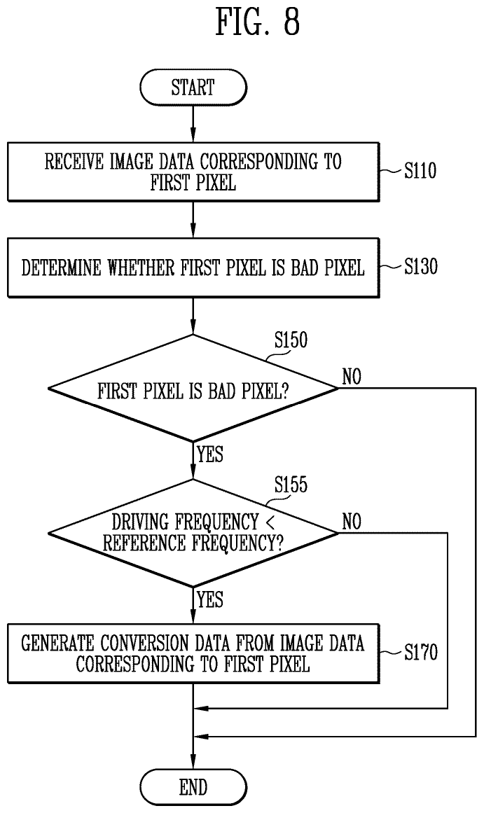

In one or more embodiments, if the driving frequency of the current display device is about 30 Hz or higher (for example, about 60 Hz), the data generator 163 may output the second image data IDATA2 having a grayscale of 30 as the conversion data CDATA based on the control signal CTRL. The above will be described again with reference to FIG. 8.

FIG. 7 is a flowchart illustrating an operating method of a display device according to one or more other embodiments of the present disclosure.

Referring to FIG. 7, the operating method of a display device according to one or more other embodiments of the present disclosure includes an operation of receiving image data corresponding to a first pixel (S110), an operation of determining whether the first pixel is defective (S130), and an operation of converting the image data corresponding to the first pixel to generate converted data if the first pixel is defective (S150: YES) (S170). The operations illustrated in FIG. 7 may be performed by the data converter 160 in FIG. 5.

In operation S110, image data corresponding to the first pixel is received. At this time, the first pixel may be any one of the pixels included in the display unit 111. In one or more embodiments, the image data of operation S110 may be the second image data IDATA2 illustrated in FIG. 5. For example, in operation S110, the data converter 160 may receive the second image data IDATA2 from the timing controller 141.

In operation S130, it is determined whether the first pixel is a defective pixel. As described above, the defective pixel determiner 161 of the data converter 160 may store information on defective pixels among the plurality of pixels included in the display unit 111. The defective pixel determiner 161 may determine whether the first pixel is a defective pixel based on the location data ILOC.

If the first pixel is a defective pixel (S150: YES), the defective pixel determiner 161 generates a control signal CTRL to control the data generator 163 to convert the received image data, for example, the second image data IDATA2. In response to the control signal CTRL, the data generator 163 may generate conversion data CDATA (S170). The grayscale of the conversion data CDATA generated in operation S170 may be lower than the grayscale of the received image data, for example, the second image data IDATA2.

As an example of operation S170, the data generator 163 may output the grayscale data having the grayscale of black as the conversion data CDATA regardless of the second image data IDATA2. In this case, the first pixel may be recognized as a dark spot.

As another example of operation S170, the data generator 163 may multiply the second image data IDATA2 by a correction coefficient greater than 0 and less than 1, and may output the result as the conversion data CDATA. In this case, the conversion data CDATA has a lower grayscale than the original second image data IDATA2. Accordingly, the problem of pixels including defective transistors being recognized as bright spots is alleviated.

If the first pixel is not a defective pixel (S150: NO), the operation in FIG. 7 may be terminated. For example, if the first pixel is not a defective pixel (S150: NO), the data generator 163 outputs the second image data IDATA2 as it is without converting it. Accordingly, the first pixel, which is a normal pixel, may generate light corresponding to the grayscale of the second image data IDATA2.

In FIG. 7, operations S110, S130, S150, and S170 are illustrated as being performed for image data corresponding to the first pixel among a plurality of pixels. In one or more embodiments, the operations illustrated in FIG. 7 may be performed sequentially corresponding to each of the plurality of pixels included in the display unit 111.

As illustrated in FIG. 7, according to the operating method of the display device according to one or more embodiments of the present disclosure, conversion data having a lower grayscale than the image data corresponding to the defective pixel is generated. Because the defective pixel generates light based on the conversion data, the problem of the defective pixel generating too much light and being recognized as a bright spot may be alleviated.

FIG. 8 is a flowchart illustrating an operating method of a display device according to one or more other embodiments of the present disclosure. Referring to FIG. 8, the operating method of a display device according to one or more other embodiments of the present disclosure includes an operation of receiving image data corresponding to a first pixel (S110), an operation of determining whether the first pixel is defective (S130), an operation of determining whether the driving frequency is lower than a reference frequency (S150: YES) if the first pixel is defective (S150: YES), an operation of determining whether the driving frequency is lower than, or less than, a reference frequency (S155), and an operation of converting image data corresponding to the first pixel to generate converted data (S170) if the driving frequency is lower than the reference frequency (S155: YES).

Referring to FIG. 8, operations S110, S130, S150, and S170 are substantially the same as operations S110, S130, S150, and S170 illustrated in FIG. 7. Therefore, the redundant description of these operations S110, S130, S150, and S170 will not be provided. In one or more embodiments, the operations illustrated in FIG. 8 may be performed by the data converter 160 in FIG. 5.

If the first pixel is a defective pixel (S150: YES), the defective pixel determiner 161 determines whether the driving frequency of the current display device 101 is lower than the reference frequency based on the driving frequency information DFR. As described in FIGS. 4A to 4C, if some transistors in the pixel are defective, the lower the driving frequency, the higher the probability that the corresponding pixel may be recognized as a bright spot. Therefore, the defective pixel determiner 161 may generate a control signal CTRL for controlling the data generation operation of the data generator 166 based on whether the driving frequency is lower than the reference frequency.

If the driving frequency of the display device 101 is lower than the reference frequency, the defective pixel determiner 161 generates a control signal CTRL to control the data generator 163 to convert the received image data, for example, the second image data IDATA2. In response to the control signal CTRL, the data generator 163 may generate the conversion data CDATA (S170). The grayscale of the conversion data CDATA generated in operation S170 may be lower than the grayscale of the received image data, for example, the second image data IDATA2.

As an example of operation S170, the data generator 163 may output grayscale data having a grayscale of black as the conversion data CDATA regardless of the second image data IDATA2. In this case, the first pixel may be recognized as a dark spot.

As another example of operation S170, the data generator 163 may multiply the second image data IDATA2 by a correction coefficient greater than 0 and less than 1, and may output the result as the conversion data CDATA. In this case, the conversion data CDATA has a lower grayscale than the original second image data IDATA2. Accordingly, the problem of pixels including defective transistors being recognized as bright spots is alleviated.

If the first pixel is not a defective pixel (S150: NO), or if the driving frequency of the display device 101 is lower than the reference frequency, the operation in FIG. 8 may be terminated. For example, if the first pixel is not a defective pixel (S150: NO), or if the driving frequency of the display device 101 is lower than the reference frequency, the data generator 163 outputs the second image data IDATA2 as it is without converting it. Accordingly, the first pixel may generate light corresponding to the grayscale of the second image data IDATA2.

As illustrated in FIG. 8, according to the operating method of the display device according to one or more embodiments of the present disclosure, if a defective pixel operates at a driving frequency lower than the reference frequency, conversion data having a lower grayscale than the received image data is generated. Because the defective pixel generates light based on the conversion data, the problem of the defective pixel generating too much light and being recognized as a bright spot may be alleviated.

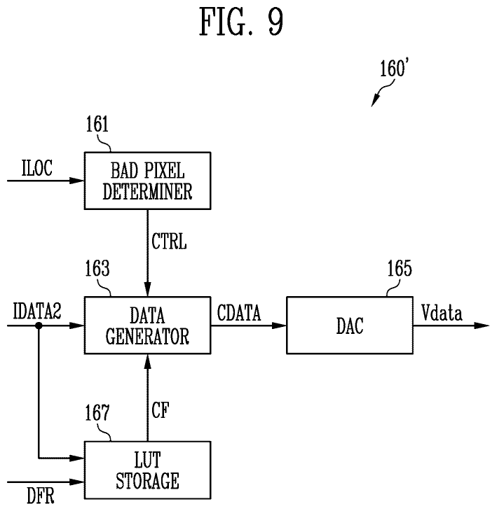

FIG. 9 is a block diagram illustrating one or more other embodiments of the data converter in FIG. 5.

Referring to FIG. 9, a data converter 160′ may include a defective pixel determiner 161, a data generator 163, a digital-to-analog converter 165, and a lookup table storage 167. Referring to FIG. 9 and FIG. 6 together, the data converter 160′ in FIG. 9 is different from the data converter 160 in FIG. 6 in that it further includes the lookup table storage 167. In the following, any part of the description of each component in FIG. 9 that overlaps with the content (e.g., amount) described through FIG. 6 will not be provided.

The defective pixel determiner 161 receives location data ILOC from the timing controller 141. The location data ILOC may indicate the position of a pixel corresponding to the second image data IDATA2. The defective pixel determiner 161 may determine whether a pixel corresponding to the second image data IDATA2 is defective based on the location data ILOC. To this end, the defective pixel determiner 161 may store the location data of defective pixels.

The lookup table storage 167 may receive the driving frequency information DFR of the display device 101 and the second image data IDATA2. The lookup table storage 167 may be to transmit the correction coefficient CF corresponding to the driving frequency of the display device 101 and the grayscale of the second image data IDATA2 to the data generator 163. To this end, the lookup table storage 167 may store a lookup table including a plurality of correction coefficients corresponding to the driving frequency and the grayscale of the second image data IDATA2. For example, the lookup table storage 167 may store a lookup table as illustrated in Table 1.

TABLE 1

| | 1~32 | 33~64 | 65~96 | 97~120 | 121~180 |
|---|---|---|---|---|---|
| Grayscale | Hz | Hz | Hz | Hz | Hz |
| 0~31 | k11 | k12 | k13 | k14 | k15 |
| 32~63 | k21 | k22 | k23 | k24 | k25 |
| 64~95 | k31 | k32 | k33 | k34 | k35 |
| 96~127 | k41 | k42 | k43 | k44 | k45 |
| 128~159 | k51 | k52 | k53 | k54 | k55 |
| 160~191 | k61 | k62 | k63 | k64 | k65 |
| 192~223 | k71 | k72 | k73 | k74 | k75 |
| 224~256 | k81 | k82 | k83 | k84 | k85 |

In Table 1, the driving frequency is divided into five ranges, and the grayscale of the second image data IDATA2 is divided into eight ranges. Accordingly, the lookup table a total of 40 correction coefficients k11˜k15, k21˜k25, k31˜k35, k41˜k45, k51˜k55, k61˜k65, k71˜k75, and k81˜k85.

In one or more embodiments, the correction coefficients k11˜k15, k21˜k25, k31˜k35, k41˜k45, k51˜k55, k61˜k65, k71˜k75, and k81˜k85 included in the lookup table may be numbers greater than 0 and less than 1, respectively.

If the pixel includes defective transistors, as the size of the second image data IDATA2 increases, the leakage current value from the first node N1 may increase. In this case, as the size of the second image data IDATA2 increases, the intensity of light generated by the defective pixel may increase compared to the normal pixel. Accordingly, in one or more embodiments, as the grayscale of the second image data IDATA2 increases under a constant driving frequency condition, the size of the corresponding correction coefficient may decrease.

If a pixel includes defective transistors, the lower the driving frequency of the display device 101, the higher the possibility that the pixel may be recognized as a bright spot. Accordingly, the lower the driving frequency of the display device 101, the larger the size of the corresponding correction coefficient. Examples of actual correction coefficients of the lookup table reflecting such characteristics are as illustrated in Table 2.

TABLE 2

| | 1~32 | 33~64 | 65~96 | 97~120 | 121~180 |
|---|---|---|---|---|---|
| Grayscale | Hz | Hz | Hz | Hz | Hz |
| 0~31 | 0.55 | 0.66 | 0.77 | 0.88 | 0.99 |
| 32~63 | 0.53 | 0.64 | 0.75 | 0.86 | 0.97 |
| 64~95 | 0.51 | 0.62 | 0.73 | 0.84 | 0.95 |
| 96~127 | 0.49 | 0.60 | 0.71 | 0.82 | 0.93 |
| 128~159 | 0.47 | 0.58 | 0.69 | 0.80 | 0.91 |
| 160~191 | 0.45 | 0.56 | 0.67 | 0.78 | 0.89 |
| 192~223 | 0.43 | 0.54 | 0.65 | 0.76 | 0.87 |
| 224~256 | 0.41 | 0.52 | 0.63 | 0.74 | 0.85 |

The lookup table storage 162 may refer to the lookup table to transmit a correction coefficient CF corresponding to the driving frequency of the display device 101 and the grayscale of the second image data IDATA2 to the data generator 163.

The data generator 166 generates conversion data CDATA from the second image data IDATA2 based on the control signal CTRL received from the defective pixel determiner 161 and the correction coefficient CF received from the lookup table storage 167. The generated conversion data CDATA is transmitted to the digital-to-analog converter 168. The digital-to-analog converter 168 generates a data signal Vdata from the conversion data CDATA in a digital form.

For example, if a pixel corresponding to the second image data IDATA2 is determined to be a normal pixel, the data generator 163 may output the second image data IDATA2 as the conversion data CDATA without conversion in response to the control signal CTRL.

In one or more embodiments, if a pixel corresponding to the second image data IDATA2 is determined to be a defective pixel, the data generator 163 may multiply the second input image data IDATA2 by a correction coefficient CF, and may output the result as the conversion data CDATA. Because the correction coefficient CF is greater than 0 and less than 1, the grayscale of the conversion data CDATA is lower than the grayscale of the second image data IDATA2. Accordingly, the problem of defective pixels generating too much light and being recognized as bright spots may be alleviated.

For example, assume that the second image data IDATA2 corresponds to a grayscale of 145 among the grayscales in a range of 0 to 255, and the driving frequency is about 80 Hz. Referring to Table 2, the correction coefficient CF corresponding to the grayscale of 145 and the driving frequency of about 80 Hz is 0.69. The value obtained by multiplying the grayscale of 145 of the second image data IDATA2 by the correction coefficient CF of 0.69 is 100.05. Because the grayscale of the conversion data CDATA may be a natural number from 0 to 255, in this case, the grayscale of the conversion data CDATA may be 100, which is rounded down to the first decimal place from 100.05.

In this way, according to the display device according to one or more embodiments of the present disclosure, the image data corresponding to the defective pixel is multiplied by a correction coefficient greater than 0 and less than 1 to generate the conversion data. Accordingly, the problem of the defective pixel generating too much light and being recognized as a bright spot may be alleviated.

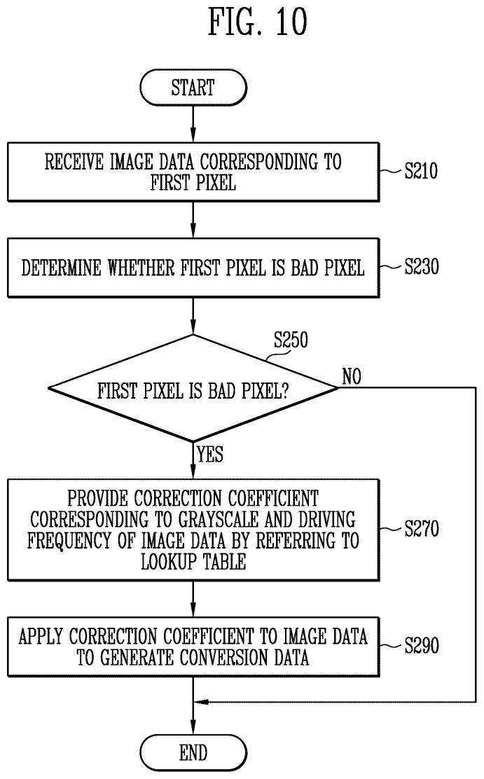

FIG. 10 is a flowchart illustrating an operating method of a display device according to one or more other embodiments of the present disclosure.

Referring to FIG. 10, the operating method of a display device according to one or more other embodiments of the present disclosure includes an operation of receiving image data corresponding to a first pixel (S210), an operation of determining whether the first pixel is defective (S230), an operation of providing a correction coefficient corresponding to the grayscale and driving frequency of the image data by referring to a lookup table if the first pixel is defective (S250: YES), and an operation of applying the correction coefficient to the image data to generate the conversion data (S290).

In operation S210, image data corresponding to the first pixel is received. In operation S210, the data converter 160 may receive second image data IDATA2 from the timing controller 141.

In operation S230, it is determined whether the first pixel is a defective pixel. As described above, the defective pixel determiner 161 of the data converter 160 may store information on defective pixels among a plurality of pixels included in the display unit 111. The defective pixel determiner 161 may determine whether the first pixel is a defective pixel based on the location data ILOC.

If the first pixel is a defective pixel (S250: YES), the lookup table storage 167 may provide the data generator 163 with a correction coefficient CF corresponding to the grayscale of the image data (for example, the second image data IDATA2) and the driving frequency of the display device 101 by referring to the stored lookup table.

In operation S290, the data generator 163 may multiply the second input image data IDATA2 by the correction coefficient CF and may generate the result as converted data CDATA.

If the first pixel is not a defective pixel (S250: NO), the operation in FIG. 10 may be terminated. For example, if the first pixel is not a defective pixel (S250: NO), the data generator 163 outputs the second image data IDATA2 as it is without converting it. Accordingly, the first pixel, which is a normal pixel, may generate light corresponding to the grayscale of the second image data IDATA2.

Referring to FIG. 7 and FIG. 10 together, operations S210, S230, and S250 in FIG. 10 may be substantially the same as operations S110, S130, and S150 in FIG. 7, respectively. In one or more embodiments, operations S270 and S290 in FIG. 10 may be included in operation S170 in FIG. 7.

As illustrated in FIG. 10, according to the operating method of the display device according to one or more embodiments of the present disclosure, conversion data having a lower grayscale than the image data is generated utilizing a correction coefficient determined based on the driving frequency and the grayscale of the image data. Because the defective pixel generates light based on the conversion data, the problem of the defective pixel generating too much light and being recognized as a bright spot may be alleviated.

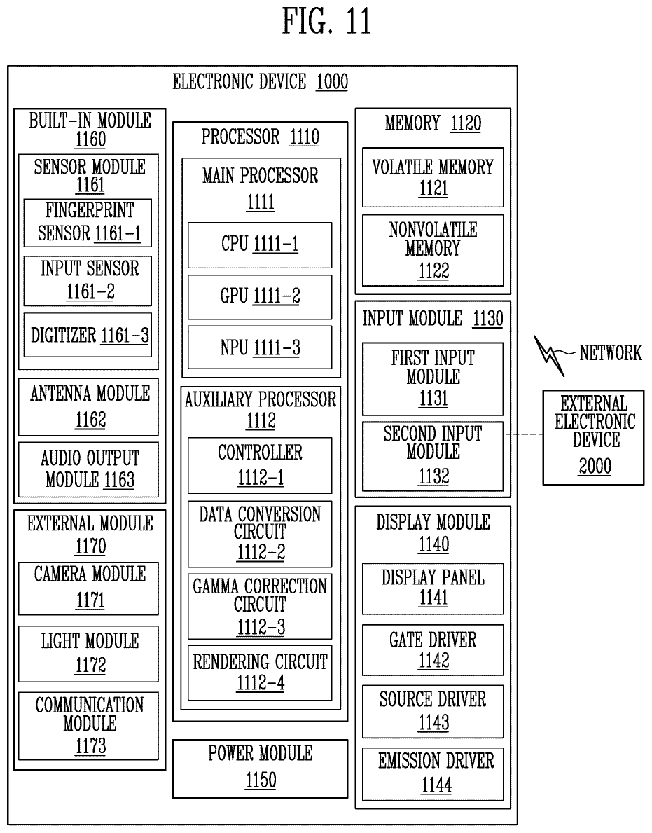

FIG. 11 is a drawing illustrating an electronic device according to one or more other embodiments of the present disclosure.

Referring to FIG. 11, the electronic device outputs information through a display module 1140. The display module 1140 may correspond to at least a part of the display device 100 or 101 in FIG. 1 or FIG. 5. If the processor 1110 executes an application stored in the memory 1120, the display module 1140 provides application information to the user through the display panel 1141. The display panel 1141 may be a configuration corresponding to the display unit 110 or 111 in FIG. 1 or FIG. 5.

The processor 1110 obtains external input through the input module 1130 or the sensor module 1161 and executes an application corresponding to the external input. For example, if a user selects a camera icon displayed on a display panel 1141, the processor 1110 acquires user input through an input sensor 1161-3 and activates a camera module 1171. The processor 1110 transmits image data corresponding to a captured image acquired through the camera module 1171 to the display module 1140. The display module 1140 may display an image corresponding to the captured image through the display panel 1141.

As another example, if personal information authentication is executed in the display module 1140, the fingerprint sensor 1161-1 acquires the input fingerprint information as input data. The processor 1110 compares the input data acquired through the fingerprint sensor 1161-1 with the authentication data stored in the memory 1120 and executes an application according to the comparison result. The display module 1140 may display information executed according to the logic of the application through the display panel 1141.

As another example, if a music streaming icon displayed on the display module 1140 is selected, the processor 1110 acquires user input through the input sensor 1161-3 and activates the music streaming application stored in the memory 1120. If a music execution command is input in the music streaming application, the processor 1110 activates the audio output module 1163 to provide the user with audio information corresponding to the music execution command.

The operation of the electronic device 1000 has been briefly described above. The configuration of the electronic device 1000 will be described in detail. Some of the configurations of the electronic device 1000 described may be integrated and provided as one configuration, and one configuration may be provided by separating it into two or more configurations.

The electronic device 1000 may communicate with an external electronic device 2000 via a network (for example, a short-range wireless communication network or a long-range wireless communication network). According to one or more embodiments, the electronic device 1000 may include a processor 1110, a memory 1120, an input module 1130, a display module 1140, a power module 1150, a built-in module 1160, and an external module 1170. According to one or more embodiments, the electronic device 1000 may omit at least one of the above-described components or may have one or more other components added. According to one or more embodiments, some of the above-described components (for example, the sensor module 1161, the antenna module 1162, or the audio output module 1163) may be integrated into another component (for example, the display module 1140).

The processor 1110 may execute software to control at least one other component (for example, a hardware or software component) of the electronic device 1000 connected to the processor 1110 and perform one or more suitable data processing or operations. According to one or more embodiments, as at least part of the data processing or operations, the processor 1110 may store commands or data received from other components (for example, the input module 1130, the sensor module 1161, or the communication module 1173) in a volatile memory 1121, process the commands or data stored in the volatile memory 1121, and store the resulting data in a nonvolatile memory 1122.

The processor 1110 may include a main processor 1111 and an auxiliary processor 1112. The auxiliary processor 1112 may correspond to at least a part of the configuration of the timing controller 140 or 141 in FIG. 1 or FIG. 5.

The main processor 1111 may include at least one of a central processing unit 1111-1 (CPU) or an application processor (AP). The main processor 1111 may further include at least one of a graphic processing unit 1111-2 (GPU), a communication processor (CP), and an image signal processor (ISP). The main processor 1111 may further include a neural network processing unit 1111-3 (NPU). The neural network processing unit is a processor specialized in processing an artificial intelligence model, and the artificial intelligence model may be generated through machine learning. The artificial intelligence model may include a plurality of artificial neural network layers. The artificial neural network may be one of a deep neural network (DNN), a convolutional neural network (CNN), a recurrent neural network (RNN), a restricted Boltzmann machine (RBM), a deep belief network (DBN), a bidirectional recurrent deep neural network (BRDNN), deep Q-networks, or a combination of two or more of the above, but is not limited to the examples described above. In addition to the hardware structure, the artificial intelligence model may additionally or alternatively include a software structure. At least two of the processing units and processors described above may be implemented as a single integrated configuration (for example, a single chip), or each may be implemented as an independent configuration (for example, a plurality of chips).

The auxiliary processor 1112 may include a controller 1112-1. The controller 1112-1 may include an interface conversion circuit and a timing control circuit. The controller 1112-1 receives an image signal from the main processor 1111, converts the data format of the image signal to match the interface specifications with the display module 1140, and outputs the image data.

The auxiliary processor 1112 may further include a data conversion circuit 1112-2, a gamma correction circuit 1112-3, a rendering circuit 1112-4, and/or the like. The data conversion circuit 1112-2 may receive the image data from the controller 1112-1, and may compensate the image data so that the image is displayed at a suitable brightness according to the characteristics of the electronic device 1000 or the user's settings and/or the like, or convert the image data to reduce power consumption or compensate for afterimages and/or the like.

The gamma correction circuit 1112-3 may convert the image data, the gamma reference voltage, and/or the like so that the image displayed on the electronic device 1000 has the suitable gamma characteristics. The rendering circuit 1112-4 may receive image data from the controller 1112-1, and may render the image data by considering the pixel layout of the display panel 1141 applied to the electronic device 1000. At least one of the data conversion circuit 1112-2, the gamma correction circuit 1112-3, and the rendering circuit 1112-4 may be integrated into another component (for example, the main processor 1111 or the controller 1112-1). At least one of the data conversion circuit 1112-2, the gamma correction circuit 1112-3, and the rendering circuit 1112-4 may also be integrated into the source driver 1143 described.

The memory 1120 may store one or more suitable pieces of data utilized by at least one component (for example, the processor 1110 or the sensor module 1161) of the electronic device 1000 and input data or output data for commands related thereto. The memory 1120 may include at least one of the volatile memory 1121 or the nonvolatile memory 1122.

The input module 1130 may receive commands or data to be utilized for components (for example, the processor 1110, the sensor module 1161, or the audio output module 1163) of the electronic device 1000 from the outside of the electronic device 1000 (for example, a user or the external electronic device 2000).

The input module 1130 may include a first input module 1131 into which a command or data is input from a user, and a second input module 1132 into which a command or data is input from an external electronic device 2000. The first input module 1131 may include a microphone, a mouse, a keyboard, a key (for example, a button), or a pen (for example, a passive pen or an active pen). The second input module 1132 may support a designated protocol that may be connected to the external electronic device 2000 by wire or wirelessly. According to one or more embodiments, the second input module 1132 may include a high definition multimedia interface (HDMI), a universal serial bus (USB) interface, an SD card interface, or an audio interface. The second input module 1132 may include a connector that may be physically connected to an external electronic device 2000, for example, an HDMI connector, a USB connector, an SD card connector, or an audio connector (for example, a headphone connector).

The display module 1140 provides visual information to the user. The display module 1140 may include a display panel 1141, a gate driver 1142, a source driver 1143, and an emission driver 1144. The gate driver 1142 may correspond to at least a part of the scan driver 120 or 121 illustrated in FIG. 1 or FIG. 5. The source driver 1143 may correspond to at least a part of the data driver 130 or 131 illustrated in FIG. 1 or FIG. 5. The emission driver 1144 may correspond to at least a part of the emission driver 150 or 151 illustrated in FIG. 1 or FIG. 5. The display module 1140 may further include a window, a chassis, and a bracket for protecting the display panel 1141.

The display panel 1141 (or display) may include a liquid crystal display panel, an organic light-emitting display panel, or an inorganic light-emitting display panel, and the type or kind of the display panel 1141 is not particularly limited. The display panel 1141 may be a rigid type (or kind) or a flexible type (or kind) that is rollable or foldable. The display module 1140 may further include a supporter that supports the display panel 1141, a bracket, or a heat-dissipating member.

The gate driver 1142 may be mounted on the display panel 1141 as a driving chip. Additionally, the gate driver 1142 may be integrated into the display panel 1141. For example, the gate driver 1142 may include an ASG (Amorphous Silicon TFT Gate driver circuit), an LTPS (Low-Temperature Polycrystalline Silicon TFT Gate driver circuit), or an OSG (Oxide Semiconductor TFT Gate driver circuit) embedded in the display panel 1141.

The emission driver 1144 may be mounted on the display panel 1141 as a driving chip. In one or more embodiments, the emission driver 1144 may be integrated into the display panel 1141 like the gate driver 1142. The emission driver 1144 may be separate from the gate driver 1142 or may be integrated into the gate driver 1142. Additionally, the emission driver 1144 may generate an emission control signal in response to an emission start signal supplied from the start signal control unit 516.

The source driver 1143 may be integrated into another component (for example, the controller 1112-1). The functions of the interface conversion circuit and the timing control circuit of the above-described controller 1112-1 may be integrated into the source driver 1143.

The display module 1140 may further include a voltage generation circuit. The voltage generation circuit may output one or more suitable voltages suitable for driving the display panel 1141. In one or more embodiments, the display panel 1141 may include a plurality of pixel columns, each of which includes a plurality of pixels.

In one or more embodiments, the source driver 1143 may convert data (for example, output data Dout) corresponding to red (R), green (G), and blue (B) included in the image data received from the processor 1110 into a red data signal (or data voltage), a green data signal, and a blue data signal, and may provide the data to a plurality of pixel columns included in the display panel 1141 during one horizontal period.

The power module 1150 supplies power to components of the electronic device 1000. The power module 1150 may include a battery that charges the power supply voltage. The battery may include a non-rechargeable primary battery, a rechargeable secondary battery, or a fuel cell. The power module 1150 may include a power management integrated circuit (PMIC). The PMIC supplies power improved or optimized for each of the modules described above and the modules described. The power module 1150 may include a wireless power transmission/reception member electrically connected to the battery. The wireless power transmission/reception member may include a plurality of coil-shaped antenna radiators.

The electronic device 1000 may further include a built-in module 1160 and an external module 1170. The built-in module 1160 may include a sensor module 1161, an antenna module 1162, and an audio output module 1163. The external module 1170 may include a camera module 1171, a light module 1172, and a communication module 1173.

The sensor module 1161 may detect an input by the user's body or an input by the pen among the first input modules 1131, and may generate an electric signal or data value corresponding to the input. In one or more embodiments, the sensor module 1161 may detect an external environment (for example, illuminance, temperature, and/or the like), and may generate an electric signal or data value corresponding to the external environment.

The sensor module 1161 may include at least one of a fingerprint sensor 1161-1, a photosensor 1161-2, or an input sensor 1161-3. The fingerprint sensor 1161-1 may generate a data value corresponding to the user's fingerprint. The fingerprint sensor 1161-1 may include either an optical or capacitive fingerprint sensor.

The photosensor 1161-2 (or the illuminance sensor) may detect the external illuminance, and may provide an electric signal or data value corresponding to the detected illuminance to the auxiliary processor 1112 (or the processor 1110). Additionally, the photosensor 1161-2 may provide a photo-sensing signal PS to the controller 1112-1 at the time if the illuminance is sensed. The controller 1112-1 supplied with the photo-sensing signal PS may control the number of off-periods included in the light emission start signal. For example, the controller 1112-1 may control the light emission start signal so that a smaller number of off-periods of the emission control signal are included in one frame period of the second driving frequency if the photo-sensing signal PS is supplied.

The input sensor 1161-3 may generate a data value corresponding to the coordinate information of an input by the user's body or an input by the pen. The input sensor 1161-3 generates the amount of change in electrostatic capacity due to an input as a data value. The input sensor 1161-3 may detect an input by a passive pen or transmit and receive data with an active pen.

The input sensor 1161-3 may also measure a biosignal, such as blood pressure, moisture, or body fat. For example, if a user touches a part of his/her body to a sensor layer or a sensing panel and does not move for a certain period of time, the input sensor 1161-3 may detect a biosignal based on an electric field change by the part of his/her body, and may output information suitable by the user to the display module 1140.

The sensor module 1161 may further include a digitizer. The digitizer may generate a data value corresponding to the coordinate information of an input by a pen. The digitizer generates an electromagnetic change due to an input as a data value. The digitizer may detect an input by a passive pen or transmit and receive data with an active pen.

At least one of the fingerprint sensor 1161-1, the photosensor 1161-2, and the input sensor 1161-3 may be implemented as a sensor layer on the display panel 1141 through a substantially continuous process.

At least two or more of the fingerprint sensor 1161-1, the photosensor 1161-2, and the input sensor 1161-3 may be integrated into one sensing panel through the same process. If integrated into one sensing panel, the sensing panel may be arranged between the display panel 1141 and a window arranged on the upper side of the display panel 1141. According to one or more embodiments, the sensing panel may be arranged on the window, and the position of the sensing panel is not particularly limited.

At least one of the fingerprint sensor 1161-1, the photosensor 1161-2, and the input sensor 1161-3 may be built into the display panel 1141. For example, at least one of the fingerprint sensor 1161-1, the photosensor 1161-2, or the input sensor 1161-3 may be formed concurrently (e.g., substantially simultaneously) through a process of forming (or providing) elements (for example, light-emitting elements, transistors, and/or the like) included in the display panel 1141.

In one or more embodiments, the sensor module 1161 may generate an electric signal or data value corresponding to an internal state or an external state of the electronic device 1000. The sensor module 1161 may further include, for example, a gesture sensor, a gyro sensor, a pressure sensor, a magnetic sensor, an acceleration sensor, a grip sensor, a proximity sensor, a color sensor, an IR (infrared) sensor, a biometric sensor, a temperature sensor, or a humidity sensor.

The antenna module 1162 may include one or more antennas for transmitting or receiving signals or power to or from the outside. According to one or more embodiments, the communication module 1173 may be to transmit or receive signals to or from an external electronic device through an antenna suitable for a communication method. The antenna pattern of the antenna module 1162 may be integrated into one component of the display module 1140 (for example, the display panel 1141) or the input sensor 1161-3.

The audio output module 1163 is a device for outputting audio signals to the outside of the electronic device 1000 and may include, for example, a speaker utilized for general purposes, such as multimedia playback or recording playback, and a receiver utilized exclusively for phone reception. According to one or more embodiments, the receiver may be integral with, or separate from, the speaker. The audio output pattern of the audio output module 1163 may be integrated into the display module 1140.

The camera module 1171 may capture still images and moving images. According to one or more embodiments, the camera module 1171 may include one or more lenses, image sensors, or image signal processors. The camera module 1171 may further include an infrared camera capable of measuring the presence or absence of a user, the user's location, the user's line of sight, and/or the like.

The light module 1172 may provide light. The light module 1172 may include a light-emitting diode or a xenon lamp. The light module 1172 may operate in conjunction with the camera module 1171 or may operate independently.

The communication module 1173 may support the establishment of a wired or wireless communication channel between the electronic device 1000 and the external electronic device 2000 and the performance of communication through the established communication channel. The communication module 1173 may include one or both of a wireless communication module, such as a cellular communication module, a short-range wireless communication module, or a global navigation satellite system (GNSS) communication module, and a wired communication module, such as a local area network (LAN) communication module, or a power line communication module. The communication module 1173 may communicate with an external electronic device 2000 via a short-range communication network, such as Bluetooth®, WiFi® direct, (Wi-Fi® being a registered trademark of the non-profit Wi-Fi Alliance, and Bluetooth® being a registered trademark of Bluetooth Sig, Inc., Kirkland, WA) or IrDA (infrared data association), or a long-range communication network, such as a cellular network, the Internet, or a computer network (for example, a LAN or WAN). The one or more suitable types (kinds) of communication modules 1173 described above may be implemented as one chip, or each may be implemented as a separate chip.

The input module 1130, the sensor module 1161, the camera module 1171, and/or the like may be utilized to control the operation of the display module 1140 in conjunction with the processor 1110.

The processor 1110 outputs a command or data to the display module 1140, the audio output module 1163, the camera module 1171, or the light module 1172 based on the input data received from the input module 1130. For example, the processor 1110 may generate image data in response to input data received through a mouse or an active pen, and may output the image data to the display module 1140, or may generate command data in response to the input data, and may output the image data to the camera module 1171 or the light module 1172. If no input data is received from the input module 1130 for a certain period of time, the processor 1110 may switch the operation mode of the electronic device 1000 to a relatively low power mode or a sleep mode to reduce the power consumed by the electronic device 1000.

The processor 1110 outputs a command or data to the display module 1140, the audio output module 1163, the camera module 1171, or the light module 1172 based on the sensing data received from the sensor module 1161. For example, the processor 1110 may compare authentication data authorized by the fingerprint sensor 1161-1 with authentication data stored in the memory 1120, and then execute an application based on the comparison result. The processor 1110 may execute a command or output corresponding image data to the display module 1140 based on sensing data detected by the input sensor 1161-3. The processor 1110 may control the brightness of the display panel 1141 in response to the illuminance detected by the photosensor 1161-2. If the sensor module 1161 includes a temperature sensor, the processor 1110 may receive temperature data on the temperature measured from the sensor module 1161 and further perform brightness correction and/or the like on the image data based on the temperature data.

The processor 1110 may receive measurement data on the presence or absence of a user, the user's location, the user's line of sight, and/or the like from the camera module 1171. The processor 1110 may further perform brightness correction and/or the like on the image data based on the measurement data. For example, the processor 1110 that determines the presence or absence of a user through input from the camera module 1171 may output the image data whose brightness has been corrected through the data conversion circuit 1112-2 or the gamma correction circuit 1112-3 to the display module 1140.

Some of the above components may be connected to each other through a communication method between peripheral devices, such as a bus, GPIO (general purpose input/output), SPI (serial peripheral interface), MIPI (mobile industry processor interface), or UPI (ultra path interconnect) link, and exchange signals (for example, commands or data) with each other. The processor 1110 may communicate with the display module 1140 through a mutually agreed interface, and may utilize, for example, any one of the above-described communication methods, and is not limited to the above-described communication methods.

The electronic device 1000 according to one or more suitable embodiments disclosed in this disclosure may be a device of one or more suitable forms. The electronic device 1000 may include, for example, at least one of a portable communication device (for example, a smartphone), a computer device, a portable multimedia device, a portable medical device, a camera, a wearable device, or a home appliance device. The electronic device 1000 according to the embodiments of this disclosure is not limited to the aforementioned devices.

Although the present disclosure has been described in embodiments, those skilled in the art may understand that the present disclosure may be variously modified and changed within the scope and spirit of the present disclosure described in the claims.

What is claimed is:

1. A display device comprising:
a display panel comprising pixels;
a scan driver configured to provide a scan signal to the display panel;
a data driver configured to provide a data signal corresponding to the pixels to the display panel;
a timing controller configured to control the driving of the scan driver and the data driver; and
a data converter configured to convert image data output from the timing controller to conversion data corresponding to a first pixel of the pixels based on whether the first pixel is defective, and to generate the data signal.

2. The display device of claim 1, wherein the data converter is configured to generate the conversion data having a lower grayscale than a grayscale of the image data when the first pixel is defective, and to generate the conversion data having a same grayscale as the image data when the first pixel is not defective.

3. The display device of claim 2, wherein the data converter is configured to generate the conversion data corresponding to a grayscale of black when the first pixel is defective.

4. The display device of claim 2, wherein the data converter is configured to multiply the image data by a correction coefficient that is greater than 0 and that is less than 1, and is configured to generate a result of a multiplication as the conversion data, when the first pixel is defective.

5. The display device of claim 4, wherein the correction coefficient is based on a driving frequency of the display device and the grayscale of the image data.

6. The display device of claim 1, wherein the data converter is configured to generate the conversion data having a lower grayscale than a grayscale of the image data when the first pixel is defective and a driving frequency of the display device is lower than a reference frequency, and
wherein the data converter is configured to generate the conversion data having a same grayscale as the image data when the first pixel is not defective or when the driving frequency of the display device is lower than the reference frequency.

7. The display device of claim 1, wherein the data converter comprises:
an edge data determiner configured to determine whether the first pixel is defective, and configured to generate a control signal; and
a data generator configured to selectively convert the image data based on the control signal, and configured to generate the conversion data.

8. The display device of claim 7, wherein the data converter further comprises a digital-to-analog converter configured to convert the conversion data into the data signal.

9. The display device of claim 6, wherein the data converter further comprises a lookup table storage configured to store a lookup table comprising correction coefficients corresponding to the driving frequency of the display device and the grayscale of the image data.

10. The display device of claim 9, wherein a size of a corresponding one of the correction coefficients decreases as a grayscale of the image data increases.

11. The display device of claim 9, wherein a size of a corresponding one of the correction coefficients decreases as the driving frequency decreases.

12. A method of operating a display device, the method comprising:
receiving image data corresponding to a first pixel among pixels in a display panel;
determining the first pixel is defective; and
generating conversion data from the image data.

13. The method of operating the display device of claim 12, wherein the conversion data has a lower grayscale than a grayscale of the image data.

14. The method of operating the display device of claim 13, wherein the conversion data corresponds to a grayscale of black.

15. The method of operating the display device of claim 12, wherein the generating the conversion data comprises:
providing a correction coefficient corresponding to a grayscale of the image data and a driving frequency of the display device by referring to a lookup table; and
applying the correction coefficient to the image data to generate the conversion data.

16. The method of operating the display device of claim 15, wherein the correction coefficient is greater than 0 and is less than 1.

17. A method of operating a display device, the method comprising:
receiving image data corresponding to a first pixel among pixels in a display panel;
determining the first pixel is defective;
determining a driving frequency of the display panel is less than a reference frequency; and
generating conversion data from the image data.

18. The method of operating the display device of claim 17, wherein the conversion data corresponds to a grayscale of black.

19. The method of operating the display device of claim 17, wherein the generating the conversion data comprises:
multiplying the image data by a correction coefficient that is greater than 0 and that is less than 1; and
generating a result of a multiplication as the conversion data.

20. An electronic device, comprising:
a processor to provide input image data; and
a display device to display an image based on the input image data, wherein the display device comprises:
a display panel comprising pixels;
a scan driver configured to provide a scan signal to the display panel;
a data driver configured to provide a data signal corresponding to the pixels to the display panel;
a timing controller configured to control the driving of the scan driver and the data driver; and
a data converter configured to convert image data output from the timing controller to conversion data corresponding to a first pixel of the pixels based on whether the first pixel is defective, and to generate the data signal.
